(19) United States
(12) Patent Application Publication
(10) Pub. No.: US 2005/0131828 A1
(43) Pub. Date: Jun. 16, 2005

(54) Method and system for cyber-security damage assessment and evaluation measurement (CDAEM)

(76) Inventor: Glenn Gearhart, Huntington Beach, CA (US)

Correspondence Address: Joseph C. Andras;MYERS DAWES ANDRAS & SHERMAN LLP, Suite 1150, 19900 MacArthur Blvd., Irvine, CA, 92612, US

(21) Appl. No.: 10/737,373

(22) Filed: Dec. 16, 2003

(51) Int. Cl. G06F 17/60

(52) U.S. Cl. 705/50

(57) ABSTRACT

Measurement (CDAEM) provides any entity, organization or individual with access to or possession of sensitive, confidential or secret information, defined as “protected information,” in digital format that is received, processed, stored or distributed by a computer, computer system or digital processing equipment with the capability to establish a quantifiable and definitive numerical measurement of the direct dollar and economic losses, plus the potential damage claim liability losses that would result from a cyber-crime attack, a cyber-terror attack or other man-made or natural disaster directed at a specific processing system, at a specific point in time and to provide the capability to perform sensitivity analysis of various operational system parameters to manage and enhance the performance of the specific system thereby improving the system resistance to such events and reducing the potential damage losses and mitigating the risk exposure.

### FIELD OF THE INVENTION

The present invention relates generally to any entity, organization or individual with access to, or possession of, sensitive, confidential or secret information in digital format, defined as “protected” that is received, processed, stored or distributed by a computer, computer system or digital processing equipment. The particular focus of the present invention is to provide a method, apparatus and system to enable a party, with access to a computer system or digital device and/or a digital based network, to establish, maintain and operate a Cyber-Security Damage Assessment and Evaluation Measurement (CDAEM) system which integrates and analyzes operational parameters and data to establish a quantifiable and definitive numerical measurement of the direct dollar and economic losses, plus the potential damage claim liability losses that would result from a cyber-crime attack, a cyber-terror attack or other man-made or natural disaster directed at a specific processing system, or entity, organization or individual, at a specific point in time and to provide the capability to perform sensitivity analysis of various operational system parameters to manage and enhance the performance of the specific system thereby improving the system resistance to such events and reducing the potential damage losses and mitigating the risk exposure.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described and in the drawings hereto: Copyright 2002-2003, ACAP Security, Inc., All Rights Reserved.

### BACKGROUND OF THE INVENTION

In recent years the issue of the security, confidentiality and integrity of data which is received, processed, stored and distributed by an entity, organization or individual, or that is transferred between points has become increasingly important. These concern have greatly increased as a result of an increase in cyber-crime activities, and the national awareness and increasing emphasis on the issue of the privacy of the data held by custodians, and the potential liability of data custodians for the unauthorized release of the protected information. This new legislative focus on the cyber-security of sensitive, confidential and secret information, defined as “protected” information is found in the recent Federal enactment of the Federal Information Security Management Act (FISMA), the Health Insurance Portability and Accountability Act (HIPAA), which addressed privacy of patient and medical information, the Gramm-Leach-Bliley (GLB) Act, which addressed privacy of clients financial information, plus many other Federal and State privacy laws and regulations. These legislative activities have increase the aggressive attitude of damaged-victims to pursue custodians of protected information in the recovery of damages for negligent cyber-security of the protected information.

This invention focuses on addressing at least two major issues associated with cyber-crime attacks, cyber-terror attacks and the man-made and natural disaster which can be directed at or befall a computer system and an entity, organizations or individual.

The first is the difficulty and inability of an entity, organization or individual to obtain quantitative and qualitative knowledge about the direct dollar damages and the economic dollar damages which could result from a cyber-crime attacks, cyber-terror attacks and the man-made and natural disaster and the second, is the difficulty and inability of an entity, organization or individual to obtain a definitive dollar damage estimate of the damage claim liability which could result from a cyber-crime attack or other disaster event that is cast upon the entity's, organization's or individual's cyber-security operations.

Although the prior art addresses various types and systems for measuring and evaluating computer performance, and in some cases the financial performance or cost considerations, the prior art does not provide for the type of damage loss and damage claim liability analysis and measurement capabilities provided by this invention.

With the current escalation in the actual and threatened cyber-crime attacks on a growing number of American organizations, a rapid, accurate and definitive means of measuring the dollar losses, the recovery costs and the exposure to damage-victim claim liability exposures is desperately needed.

An indication of some of the areas of performance measurement and providing cost or financial knowledge about a system such that management can make informed decisions are discussed in the recent prior art in: U.S. Pat. No. 6,219,654, Ruffin, Apr. 17, 2001, 705/400, tilted: Method, System and Program product for performing cost analysis of information technology implementation; U.S. Pat. No. 6,092,050, Lungren, Jul. 18, 2000, 705/10, titled: Graphical computer system and method for financial estimating and project management; U.S. Pat. No. 5,774,878, Marshall, Jun. 30, 1998, 705/35, tilted: Virtual reality generator for use with financial information.

### SUMMARY OF THE INVENTION

To address the above weaknesses in the prior art and other limitations of the prior art, the present invention provides for any entity, organization or individual to utilize the CDAEM system to detect vulnerabilities and measure the system's performance and operational compliance with established standards.

This invention facilitates this capability by utilizing the values of many parameters and data which represents the operational characteristics and processing environment in which a computer or some form of a digital device or group of computers and the networks and communications and processing equipment are operating where the ultimate function and purpose of the CDAEM is to establish a quantifiable and definitive numerical measurement of the direct dollar losses, economic losses an the damage claim liability exposure which the actual or proposed cyber-security system operation creates as a result of a cyber-crime attack, cyber-terror attack or other man-made or natural disaster and to provide, assemble and be capable of archiving the supporting parameters, status, states and analysis specifically associated with the numerical values which the CDAEM creates.

These and other objectives and advantages of the present invention will become clear to those skilled in the art in view of the description of the sample mode of carrying out the invention and the industrial applicability of the sample embodiment as described herein and as illustrated in the several figures of the drawings.

To the accomplishment of the foregoing and related ends, the invention, then, comprises the features hereinafter fully described and particularly pointed out in the claims. The following description and the included drawings set forth in detail certain illustrative embodiments of the invention. These embodiments are indicative, however, of but a very few of the various ways in which the principles of the invention may be employed. Other objectives, advantages and novel features of the invention will become apparent from the following detailed description of the invention when considered in conjunction with the drawings and claims.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and sub-combinations of the disclosed features and/or combinations and sub-combinations of several further features disclosed below in the detailed description.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1—illustrates a diagram of the operational inputs processing and outputs of a embodiment of a damage assessment CDAEM function in accordance with methods and systems consistent with the present invention;

### DETAILED DESCRIPTION OF AN EMBODIMENT OF THE INVENTION

Reference will now be made in detail to the construction and operation of an implementation of the present invention which is illustrated in the accompanying drawings. The present invention is not limited to this presented implementation but it may be realized by many other implementations.

The teachings of the present invention are applicable to many different types of entities, organizations and individuals utilizing different types of computer systems, computer networks and communication systems. As will be appreciated by those of ordinary skill in the art, while the following discussion sets forth various sample or even preferred implementations of the method and system of the present invention, these implementations are not intended to be restrictive of the provided claims, nor are they intended to imply that the claimed invention has limited applicability to one type of computer or communications network.

In this regard, the teachings of the present invention are equally applicable for use in such applications as cyber-security systems, cyber-security defense systems, cyber-security liability defense systems, damage claim defense activities, cyber-security related risk management, risk mitigation systems, insurance coverage pre-condition and continued coverage conditional standards performance measurement systems, litigation and damage claim defense evidence collection systems and many other cyber-security and non-cyber-security applications.

In accordance with the aforementioned needs, the present invention is directed to an CDAEM embodiment of the invention which includes: a quick-look or preliminary damage assessment function 1000; a standard or detailed damage assessment function 1001; and a sensitivity and analysis damage assessment function 1002.

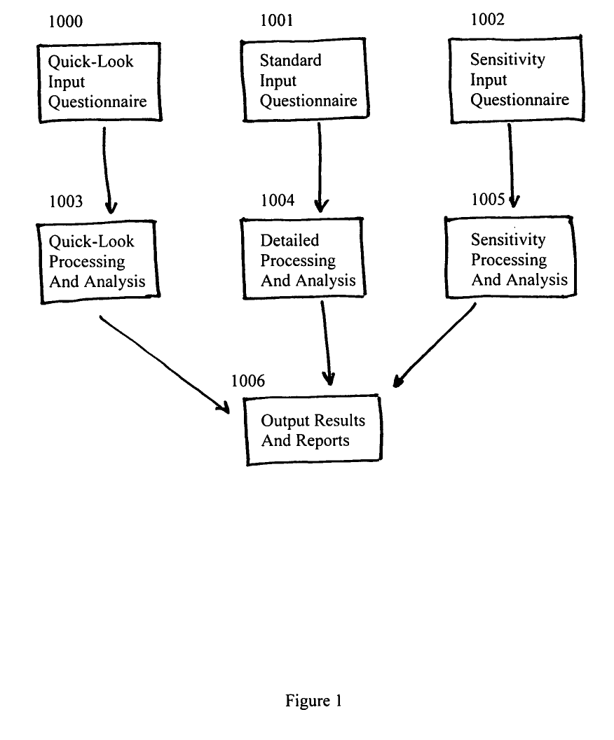

As shown in FIG. 1, these functions or sub-functions of the damage assessment function include the quick look group of sub-functions 1000, 1003 and 1006; the standard group of sub-functions 1001, 1004 and 1006; and sensitivity 1002, 1005 and 1006.

The embodiment sample quick-look input questionnaire (1000) of a damage assessment CDAEM function in accordance with methods and systems consistent with the present invention may typically include such question as:

Quick-Look Damage Assessment Questionnaire

Assessment Identification Data
Please provide a Quick Look Damage Assessment Identification Number: [us]
{check to make sure the number has not been used}
Submittal Time: [cs]
Submittal Date: [cs]
Data on party completing submittal form:
Name: [us]
ID Number: [us]
Phone number: [us]
e-mail address: [us]
Organization ID number: [us]
Organization Name: [us]
Street Address: [us]
City: [us]
State: [us]
Zip: [us]
Phone number: [us]
Fax number: [us]
e-mail address: [us]

For the remaining sections of this questionnaire a value must be provided in answer to each question. If for example there are no medical records on your organization's computer system(s) enter the number zero “0” in the entry space. Some value must be entered into every requested entry.

Identify (ID) Information

The total average number of individuals and entities whose identity information is available on your organizations computer systems and networks.
Average Number: [us]

Credit Card Number (CCN) Information

The total average number of customers, clients, patients, staff members and employees and any other parties whose credit card numbers (CCN) available on your organization's computer systems and networks.
Average Number: [us]

Debit Card Number and Bank Account Numbers (DCN) Information

The total average number of customers, clients, patients, staff members and employees and any other parties whose debit card number records and/or bank account numbers (DCN) are available on your organization's computer systems and networks.
Average Number: [us]

Bank and Financial Account Information

The estimated maximum cash available, in dollars, at all of your organization's bank accounts on an average typical day, during a typical month of operations.
Estimated Maximum Cash: [us]

Accounts Payable Information

The average maximum payments made each month by your organization to vendors, suppliers and contractors.
Average Maximum Payments: [us]

Employee Records

The total average number of active staff members and employees for which financial information is available on your organization's computer systems and networks.
Average Number: [us]

Financial Records

The total average number of active customers, clients, patients, staff members and employees and any other parties whose financial records, in electronic format, are available on your organization's computer systems and networks.
Average Number: [us]

Medical Records

The total average number of active patients for which medial information is available on your organization's computer systems and networks.
Average Number: [us]

Economic Impact

The estimated maximum lost income, in dollars, that your organization would incur during the period from initial detection to complete settlement of all disputes related to the cyber-crime attack.
Estimated Maximum Lost Income: [us]

Re-Marketing and Public Relations

The estimated maximum costs, in dollars, your organization would incur in expenses, fees and costs associated with for the preparation and delivery of a public relation and re-marketing campaign during the period from the initial detection to complete settlement of all disputes related to a cyber-crime attack.
Estimated Maximum Cost: [us]

Legal and Accounting

The estimated maximum costs, in dollars, your organization would incur in out-side legal and accounting fees and costs during the period from initial detection to complete settlement of all disputes related to the cyber-crime attack.
Estimated Maximum Cost: [us]

Ancillary Costs

The estimated maximum costs, in dollars, your organization would encounter in ancillary costs during the period from initial detection to complete settlement of all disputes related to the cyber-crime attack.
Estimated Maximum Cost: [us]

{End of Quick-Look Damage Assessment Questionnaire}

In a similar manner the embodiment sample standard input questionnaire (1001) of a damage assessment CDAEM function in accordance with methods and systems consistent with the present invention may typically include such question as:

Standard Damage Assessment Questionnaire

Assessment Identification Data
Please provide a Standard Damage Assessment Identification Number: [us]
Submittal Time: [cs]
Submittal Date: [cs]
Data on party completing submittal form:
Name: [us]
ID Number: [us]
Phone number: [us]
e-mail address: [us]
Organization ID number: [us]
Organization Name: [us]
Street Address: [us]
City: [us]
State: [us]
Zip: [us]
Phone number: [us]
Fax number: [us]
e-mail address: [us]

For the remaining sections of this questionnaire a value must be provided in answer to each question. If for example there are no medical records on your organization's computer system(s) enter the number zero “0” in the entry space. Some value must be entered into every requested entry.

[4.2] Identify (ID) Information

The damage analysis process requires your organization to provide the following information:

Item (1A) The average number of customers, clients, patients, staff members and employees and any other parties whose identity (ID) information records are available, in electronic format, on your organization's computer system(s)—the total average number of individuals' and entities' identities available on your organization's computer systems and networks.
Average Total Number: [us]

Item (1B) If your organization has implemented an ACAP System and has “AWrapped” some or all of the identities (IDs), please provide the total average number of individuals' and entities' identities that have been AWrapped on your organization's computer systems and networks.
Average Total Number AWrapped: [us]

Item (1C) If your organization has implemented an ACAP System and has “AWrapped” some or all of the identities (IDs), please provide the maximum average number of individuals' and entities' identities that would be unlocked (that is, be opened or non-AWrapped) during a normal days processing operations.
Maximum average number of “unlocked” identities [us]

Item (1D) If your organization has implemented an ACAP System and has “ASplit” some or all of the identities (IDs), please provide the total average number of individuals' and entities' identities that have been ASplit on your organization's computer systems and networks.
Average Total Number ASplit: [us]

Item (2) Average minimum and average maximum dollar loss value from each individuals' and entities' stolen identity.
Estimated Minimum Value: [$20,000] [us]
Estimated Maximum Value: [$80,000] [us]

Item (3) The estimated percentage of the total number of individuals and entities, or their third party claimants that would make damage claims against your organization if their identity information were compromised.
Estimated Percentage Number: [70%] [us]
   [4.3] Credit Card Number (CCN) Information

The damage analysis process requires your organization to provide the following information:

Item (1A) The average number of customers, clients, patients, staff members and employees and any other parties whose credit card number records (CCN) are available, in electronic format, on your organization's computer system(s)—the total average number of individuals' and entities' CCN numbers available on your organization's computer systems and networks.
Average Total Number: [us]

Item (1B) If your organization has implemented an ACAP System and has “AWrapped” some or all of the CCN numbers, please provide the total average number of individuals' and entities' CCN numbers that have been AWrapped on your organization's computer systems and networks.
Average Total Number AWrapped: [us]

Item (1C) If your organization has implemented an ACAP System and has “AWrapped” some or all of the CCN numbers, please provide the maximum average number of individuals' and entities' CCN numbers that would be unlocked (that is, be opened or non-AWrapped) during a normal days processing operations.
Maximum average number of “unlocked” CCN numbers [us]Item (1D) If your organization has implemented an ACAP System and has “ASplit” some or all of the CCN numbers, please provide the total average number of individuals' and entities' CCN numbers that have been ASplit on your organization's computer systems and networks.
Average Total Number ASplit: [us]

Item (2) The average minimum and average maximum dollar loss value from each individuals' or entities' stolen credit card number.
Estimated Minimum Value: [$2,000] [us]
Estimated Maximum Value: [$8,000] [us]

Item (3) The estimated percentage of the total number of individuals and entities, or their third party claimants that would make damage claims against your organization if their credit card number information were compromised.
Estimated Percentage Number: [50%] [us]
   [4.4] Debit Card Number and Bank Account Numbers (DCN) Information

The damage analysis process requires your organization to provide the following information:

Item (1A) The average number of customers, clients, patients, staff members and employees and any other parties whose debit card number records and/or bank account numbers (DCN) are available, in electronic format, on your organization's computer system(s)—the total average number of individuals' and entities' DCN numbers available on your organization's computer systems and networks.
Average Total Number: [us]

Item (1B) If your organization has implemented an ACAP System and has “AWrapped” some or all of the DCN numbers, please provide the total average number of individuals' and entities' DCN numbers that have been AWrapped on your organization's computer systems and networks.
Average Total Number AWrapped: [us]

Item (1C) If your organization has implemented an ACAP System and has “AWrapped” some or all of the DCN numbers, please provide the maximum average number of individuals' and entities' DCN numbers that would be unlocked (that is, be opened or non-AWrapped) during a normal days processing operations.
Maximum average number of “unlocked” DCN numbers [us]

Item (1D) If your organization has implemented an ACAP System and has “ASplit” some or all of the DCN numbers, please provide the total average number of individuals' and entities' DCN numbers that have been ASplit on your organization's computer systems and networks.
Average Total Number ASplit: [us]

Item (2) The average minimum and average maximum dollar loss value from each individuals' or entities' stolen debit card number or bank account number.
Estimated Minimum Value: [$5,000] [us]
Estimated Maximum Value: [$50,000] [us]

Item (3) The estimated percentage of the total number of individuals and entities, or their third party claimants that would make damage claims against your organization if their debit card number or bank account number information were compromised.
Estimated Percentage Number: [50%] [us]
   [4.5] Bank and Financial Account Information

The damage analysis process requires your organization to provide the following information:

Item (1) The estimated minimum and maximum potential losses to your organization caused by a bank account cash-out cyber-crime attack—the estimated minimum cash available and the maximum cash available, in dollars, at all of your organization's bank accounts on an average typical day, during a typical month of operations.
Average Minimum Cash: [us]
Average Maximum Cash: [us]
   [4.6] Accounts Payable Information

The damage analysis process requires your organization to provide the following information:

Item (1) The estimated minimum and maximum potential losses to your organization caused by an accounts payable cyber-crime attack—the average minimum and average maximum payments made each month to your organization's vendors, suppliers and contractors.
Average Minimum Payments: [us]
Average Maximum Payments: [us]
   [4.7] Employee Records

The damage analysis process requires your organization to provide the following information:

Item (1A) The average number of active staff members and employees employment records available, in electronic format, on your organization's computer system(s)—the total average number of active staff members and employees for which employment information is available on your organizations computer systems and networks.
Average Total Number (Active): [us]

Item (1B) If your organization has implemented an ACAP System and has “AWrapped” some or all of the active staff members and employees employment records, please provide the total average number of the active staff members and employees employment records that have been AWrapped on your organization's computer systems and networks.
Average Total Number AWrapped: [us]

Item (1C) If your organization has implemented an ACAP System and has “AWrapped” some or all of the active staff members and employees employment records, please provide the maximum average number of the active staff members and employees employment records that would be unlocked (that is, be opened or non-AWrapped) during a normal days processing operations.
Maximum average number of “unlocked” active records [us]

Item (1D) If your organization has implemented an ACAP System and has “ASplit” some or all of the active staff members and employees employment records, please provide the total average number of the active staff members and employees employment records that have been ASplit on your organization's computer systems and networks.
Average Total Number ASplit: [us]

Item (2A) The average number of on-leave, terminated, retired and other forms of in-active status, of your organization's staff member's and employee's employment records that are in-active or archived, in electronic format, in your organization's computer system(s)—the total average number of in-active and archived staff member's and employee's employment information available on your organization's computer system and networks including all back-up systems and achieve systems.
Average Total Number (In-Active): [us]

Item (2B) If your organization has implemented an ACAP System and has “AWrapped” some or all of the in-active staff members and employees employment records, please provide the total average number of the in-active staff members and employees employment records that have been AWrapped on your organization's computer systems and networks.
Average Total Number AWrapped: [us]

Item (2C) If your organization has implemented an ACAP System and has “AWrapped” some or all of the in-active staff members and employees employment records, please provide the maximum average number of the in-active staff members and employees employment records that would be unlocked (that is, be opened or non-AWrapped) during a normal days processing operations.
Maximum average number of “unlocked” in-active records [us]

Item (2D) If your organization has implemented an ACAP System and has “ASplit” some or all of the in-active staff members and employees employment records, please provide the total average number of the in-active staff members and employees employment records that have been ASplit on your organization's computer systems and networks.
Average Total Number ASplit: [us]

Item (3) The estimated minimum costs and the maximum costs, in dollars, your organization would encounter to settle an average employment records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [us]
Estimated Maximum Cost: [$25,000] [us]

Item (4) The estimated percentage of the total number of employees and staff members that will make damage claims against your organization if their employment records were compromised.
Estimated Percentage Number: [70%] [us]
   [4.8] Financial Records

The damage analysis process requires your organization to provide the following information:

Item (1A) The average number of active customers, clients, patients, staff members and employees and any other parties whose financial records, in electronic format, are available on your organization's computer system(s)—the total average number of active customers, clients, patients, staff members and employees and any other parties whose financial information is available on your organization's computer systems and networks.
Average Total Number (Active): [us]

Item (1B) If your organization has implemented an ACAP System and has “AWrapped” some or all of the parties' active financial records, please provide the total average number of the parties' active financial records that have been AWrapped on your organization's computer systems and networks.
Average Total Number AWrapped: [us]

Item (1C) If your organization has implemented an ACAP System and has “AWrapped” some or all of the parties' active financial records, please provide the maximum average number of the parties' active financial records that would be unlocked (that is, be opened or non-AWrapped) during a normal days processing operations.
Maximum average number of “unlocked” active records [us]

Item (1D) If your organization has implemented an ACAP System and has “ASplit” some or all of the parties' active financial records, please provide the total average number of the parties' active financial records that have been ASplit on your organization's computer systems and networks.
Average Total Number ASplit: [us]

Item (2A) The average number of in-active customers, clients, patients, staff members and employees and any other parties whose financial records, in electronic format, are available on your organization's computer system(s)—the total average number of in-active customers, clients, patients, staff members and employees and any other parties whose financial information is available on your organization's computer systems and networks including all back-up systems and achieve systems.
Average Total Number (In-Active): [us]

Item (2B) If your organization has implemented an ACAP System and has “AWrapped” some or all of the parties' in-active financial records, please provide the total average number of the parties' in-active financial records that have been AWrapped on your organization's computer systems and networks.
Average Total Number AWrapped: [us]

Item (2C) If your organization has implemented an ACAP System and has “AWrapped” some or all of the parties' in-active financial records, please provide the maximum average number of the parties' in-active financial records that would be unlocked (that is, be opened or non-AWrapped) during a normal days processing operations.
Maximum average number of “unlocked” in-active records [us]

Item (2D) If your organization has implemented an ACAP System and has “ASplit” some or all of the parties' in-active financial records, please provide the total average number of the parties' in-active financial records that have been ASplit on your organization's computer systems and networks.
Average Total Number ASplit: [us]

Item (3) The estimated minimum costs and the maximum costs, in dollars, your organization would encounter to settle an average financial records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [us]
Estimated Maximum Cost: [$25,000] [us]

Item (4) The estimated percentage of the total number of customers, clients, patients, staff members and employees and any other parties that will make damage claims against your organization if their financial records were compromised.
Estimated Percentage Number: [70%] [us]
   [4.9] Medical Records

The damage analysis process requires your organization to provide the following information:

Item (1A) The average number of active patients whose medical records, in electronic format, are available on your organization's computer system(s)—the total average number of active patients medical information available on your organization's computer systems and networks.
Average Total Number (Active): [us]

Item (1B) If your organization has implemented an ACAP System and has “AWrapped” some or all of the patients' active medical records, please provide the total average number of the patients' active medical records that have been AWrapped on your organization's computer systems and networks.
Average Total Number AWrapped: [us]

Item (1C) If your organization has implemented an ACAP System and has “AWrapped” some or all of the patients' active medical records, please provide the maximum average number of the patients' active medical records that would be unlocked (that is, be opened or non-AWrapped) during a normal days processing operations.
Maximum average number of “unlocked” active records [us]

Item (1D) If your organization has implemented an ACAP System and has “ASplit” some or all of the patients' active medical records, please provide the total average number of the patients' active medical records that have been ASplit on your organization's computer systems and networks.
Average Total Number ASplit: [us]

Item (2A) The average number of in-active patients whose medical records, and archived records, in electronic format, are available on your organization's computer system(s)—the total average number of in-active patients medical information available on your organization's computer systems and networks including all back-up systems and achieve systems.
Average Number (In-Active): [us]

Item (2B) If your organization has implemented an ACAP System and has “AWrapped” some or all of the patients' in-active medical records, please provide the total average number of the patients' active medical records that have been AWrapped on your organization's computer systems and networks.
Average Total Number AWrapped: [us]

Item (2C) If your organization has implemented an ACAP System and has “AWrapped” some or all of the patients' in-active medical records, please provide the maximum average number of the patients' in-in-active medical records that would be unlocked (that is, be opened or non-AWrapped) during a normal days processing operations.
Maximum average number of “unlocked” in-active records [us]

Item (2D) If your organization has implemented an ACAP System and has “ASplit” some or all of the patients' in-active medical records, please provide the total average number of the patients' in-active medical records that have been ASplit on your organization's computer systems and networks.
Average Total Number ASplit: [us]

Item (3) The estimated minimum costs and the maximum costs, in dollars, your organization would encounter to settle an average medical records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [us]
Estimated Maximum Cost: [$25,000] [us]

Item (4) The estimated percentage of the total number of patients that will make damage claims against your organization if their medical records were compromised.
Estimated Percentage Number: [70%] [us]
   [4.10] Password and Access Code Information

The damage analysis process requires your organization to provide the following information:

Item (1) The estimated minimum costs and the maximum costs your organization would encounter to implement the re-keying of your organization's password and access codes system.
Estimated Minimum Cost: [us]
Estimated Maximum Cost: [us]
   [4.11] Economic Impact {S11}

The damage analysis process requires your organization to provide the following information:

Item (1) The estimated minimum lost income and the maximum lost income, in dollars, that your organization would incur during the period from the initial detection to complete settlement of all disputes related to a cyber-crime attack.
Estimated Minimum Lost Income: [us]
Estimated Maximum Lost Income: [us]
   [4.12] Re-Marketing and Public Relations

The damage analysis process requires your organization to provide the following information:

Item (1) The estimated minimum costs and the maximum costs, in dollars, your organization would incur in expenses, fees and costs associated with for the preparation and delivery of a public relation and re-marketing campaign during the period from the initial detection to complete settlement of all disputes related to a cyber-crime attack.
Estimated Minimum Cost: [us]
Estimated Maximum Cost: [us]
   [4.13] Legal and Accounting

The damage analysis process requires your organization to provide the following information:

Item (1) The estimated minimum costs and the maximum costs, in dollars, your organization would incur in out-side legal and accounting fees and costs during the period from initial detection to complete settlement of all disputes related to a cyber-crime attack.
Estimated Minimum Cost: [us]
Estimated Maximum Cost: [us]
   [4.14] Ancillary Costs {S14}

The damage analysis process requires your organization to provide the following information:

Item (1) The estimated minimum costs and the maximum costs, in dollars, your organization would encounter in ancillary costs during the period from initial detection to complete settlement of all disputes related to a cyber-crime attack.
Estimated Minimum Cost: [us]
Estimated Maximum Cost: [us]
   {End of Standard Damage Assessment Questionnaire}

In a similar manner the embodiment sample standard damage assessment report (1006) of a damage assessment CDAEM function in accordance with methods and systems consistent with the present invention may typically include such information as:

Standard Damage Assessment Report
Report Preparation Time: [cs]
Report Preparation Date: [cs]
Please provide a Standard Damage Assessment Report Identification Number: [us]
Report Data Submittal Time: [cs]
Report Data Submittal Date: [cs]
Report Data Standard Damage Assessment Identification Number: [cs]
Data on party providing submitted data:
Name: [cs]
ID Number: [cs]
Phone number: [cs]
e-mail address: [cs]
Organization ID number: [cs]
Organization Name: [cs]
Street Address: [cs]
City: [cs]
State: [cs]
Zip: [cs]
Phone number: [cs]
Fax number: [cs]
e-mail address: [cs]

Estimated Assessment of Loss Exposures from a Cyber-crime Attack

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

Estimated Assessment of Damage Ranges from a Cyber-crime Attack

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

[4.2] Identify (ID) Information

The damage analysis process requires your organization to provide the following information:

Item (1A) The average number of customers, clients, patients, staff members and employees and any other parties whose identity (ID) information records are available, in electronic format, on your organization's computer system(s)—the total average number of individuals' and entities' identities available on your organization's computer systems and networks.
Average Total Number: [cs]

Item (1B) If your organization has implemented an ACAP System and has “AWrapped” some or all of the identities (IDs), please provide the total average number of individuals' and entities' identities that have been AWrapped on your organization's computer systems and networks.
Average Total Number AWrapped: [cs]

Item (1C) If your organization has implemented an ACAP System and has “AWrapped” some or all of the identities (IDs), please provide the maximum average number of individuals' and entities' identities that would be unlocked (that is, be opened or non-AWrapped) during a normal days processing operations.
Maximum average number of “unlocked” identities [cs]

Item (1D) If your organization has implemented an ACAP System and has “ASplit” some or all of the identities (IDs), please provide the total average number of individuals' and entities' identities that have been ASplit on your organization's computer systems and networks.
Average Total Number ASplit: [cs]

Item (2) Average minimum and average maximum dollar loss value from each individuals' and entities' stolen identity.
Estimated Minimum Value: [$20,000] [cs]
Estimated Maximum Value: [$80,000] [cs]

Item (3) The estimated percentage of the total number of individuals and entities, or their third party claimants that would make damage claims against your organization if their identity information were compromised.
Estimated Percentage Number: [70%] [cs]
   [4.3] Credit Card Number (CCN) Information

The damage analysis process requires your organization to provide the following information:

Item (1A) The average number of customers, clients, patients, staff members and employees and any other parties whose credit card number records (CCN) are available, in electronic format, on your organization's computer system(s)—the total average number of individuals' and entities' CCN numbers available on your organization's computer systems and networks.
Average Total Number: [cs]

Item (1B) If your organization has implemented an ACAP System and has “AWrapped” some or all of the CCN numbers, please provide the total average number of individuals' and entities' CCN numbers that have been AWrapped on your organization's computer systems and networks.
Average Total Number AWrapped: [cs]

Item (1C) If your organization has implemented an ACAP System and has “AWrapped” some or all of the CCN numbers, please provide the maximum average number of individuals' and entities' CCN numbers that would be unlocked (that is, be opened or non-AWrapped) during a normal days processing operations.
Maximum average number of “unlocked” CCN numbers [us]

Item (1D) If your organization has implemented an ACAP System and has “ASplit” some or all of the CCN numbers, please provide the total average number of individuals' and entities' CCN numbers that have been ASplit on your organization's computer systems and networks.
Average Total Number ASplit: [cs]

Item (2) The average minimum and average maximum dollar loss value from each individuals' or entities' stolen credit card number.
Estimated Minimum Value: [$2,000] [cs]
Estimated Maximum Value: [$8,000] [cs]

Item (3) The estimated percentage of the total number of individuals and entities, or their third party claimants that would make damage claims against your organization if their credit card number information were compromised.
Estimated Percentage Number: [50%] [cs]
   [4.4] Debit Card Number and Bank Account Numbers (DCN) Information {S4}

The damage analysis process requires your organization to provide the following information:

Item (1A) The average number of customers, clients, patients, staff members and employees and any other parties whose debit card number records and/or bank account numbers (DCN) are available, in electronic format, on your organization's computer system(s)—the total average number of individuals' and entities' DCN numbers available on your organization's computer systems and networks.
Average Total Number: [cs]

Item (1B) If your organization has implemented an ACAP System and has “AWrapped” some or all of the DCN numbers, please provide the total average number of individuals' and entities' DCN numbers that have been AWrapped on your organization's computer systems and networks.

Average Total Number AWrapped: [cs]

Item (1C) If your organization has implemented an ACAP System and has “AWrapped” some or all of the DCN numbers, please provide the maximum average number of individuals' and entities' DCN numbers that would be unlocked (that is, be opened or non-AWrapped) during a normal days processing operations.
Maximum average number of “unlocked” DCN numbers [cs]

Item (1D) If your organization has implemented an ACAP System and has “ASplit” some or all of the DCN numbers, please provide the total average number of individuals' and entities' DCN numbers that have been ASplit on your organization's computer systems and networks.
Average Total Number ASplit: [cs]

Item (2) The average minimum and average maximum dollar loss value from each individuals' or entities' stolen debit card number or bank account number.
Estimated Minimum Value: [$5,000] [cs]
Estimated Maximum Value: [$50,000] [cs]

Item (3) The estimated percentage of the total number of individuals and entities, or their third party claimants that would make damage claims against your organization if their debit card number or bank account number information were compromised.
Estimated Percentage Number: [50%] [cs]
   [4.5] Bank and Financial Account Information

The damage analysis process requires your organization to provide the following information:

Item (1) The estimated minimum and maximum potential losses to your organization caused by a bank account cash-out cyber-crime attack—the estimated minimum cash available and the maximum cash available, in dollars, at all of your organization's bank accounts on an average typical day, during a typical month of operations.
Average Minimum Cash: [cs]
Average Maximum Cash: [cs]
   [4.6] Accounts Payable Information

The damage analysis process requires your organization to provide the following information:

Item (1) The estimated minimum and maximum potential losses to your organization caused by an accounts payable cyber-crime attack—the average minimum and average maximum payments made each month to your organization's vendors, suppliers and contractors.
Average Minimum Payments: [cs]
Average Maximum Payments: [cs]
   [4.7] Employee Records

The damage analysis process requires your organization to provide the following information:

Item (1A) The average number of active staff members and employees employment records available, in electronic format, on your organization's computer system(s)—the total average number of active staff members and employees for which employment information is available on your organizations computer systems and networks.
Average Total Number (Active): [cs]

Item (1B) If your organization has implemented an ACAP System and has “AWrapped” some or all of the active staff members and employees employment records, please provide the total average number of the active staff members and employees employment records that have been AWrapped on your organization's computer systems and networks.
Average Total Number AWrapped: [cs]

Item (1C) If your organization has implemented an ACAP System and has “AWrapped” some or all of the active staff members and employees employment records, please provide the maximum average number of the active staff members and employees employment records that would be unlocked (that is, be opened or non-AWrapped) during a normal days processing operations.
Maximum average number of “unlocked” active records [cs]

Item (1D) If your organization has implemented an ACAP System and has “ASplit” some or all of the active staff members and employees employment records, please provide the total average number of the active staff members and employees employment records that have been ASplit on your organization's computer systems and networks.
Average Total Number ASplit: [cs]

Item (2A) The average number of on-leave, terminated, retired and other forms of in-active status, of your organization's staff member's and employee's employment records that are in-active or archived, in electronic format, in your organization's computer system(s)—the total average number of in-active and archived staff member's and employee's employment information available on your organization's computer system and networks including all back-up systems and achieve systems.
Average Total Number (In-Active): [cs]

Item (2B) If your organization has implemented an ACAP System and has “AWrapped” some or all of the in-active staff members and employees employment records, please provide the total average number of the in-active staff members and employees employment records that have been AWrapped on your organization's computer systems and networks.
Average Total Number AWrapped: [cs]

Item (2C) If your organization has implemented an ACAP System and has “AWrapped” some or all of the in-active staff members and employees employment records, please provide the maximum average number of the in-active staff members and employees employment records that would be unlocked (that is, be opened or non-AWrapped) during a normal days processing operations.
Maximum average number of “unlocked” in-active records [cs]

Item (2D) If your organization has implemented an ACAP System and has “ASplit” some or all of the in-active staff members and employees employment records, please provide the total average number of the in-active staff members and employees employment records that have been ASplit on your organization's computer systems and networks.
Average Total Number ASplit: [cs]

Item (3) The estimated minimum costs and the maximum costs, in dollars, your organization would encounter to settle an average employment records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [cs]
Estimated Maximum Cost: [$25,000] [cs]

Item (4) The estimated percentage of the total number of employees and staff members that will make damage claims against your organization if their employment records were compromised.
Estimated Percentage Number: [70%] [cs]
   [4.8] Financial Records {S8}

The damage analysis process requires your organization to provide the following information:

Item (1A) The average number of active customers, clients, patients, staff members and employees and any other parties whose financial records, in electronic format, are available on your organization's computer system(s)—the total average number of active customers, clients, patients, staff members and employees and any other parties whose financial information is available on your organization's computer systems and networks.
Average Total Number (Active): [cs]

Item (1B) If your organization has implemented an ACAP System and has “AWrapped” some or all of the parties' active financial records, please provide the total average number of the parties' active financial records that have been AWrapped on your organization's computer systems and networks.
Average Total Number AWrapped: [cs]

Item (1C) If your organization has implemented an ACAP System and has “AWrapped” some or all of the parties' active financial records, please provide the maximum average number of the parties' active financial records that would be unlocked (that is, be opened or non-AWrapped) during a normal days processing operations.
Maximum average number of “unlocked” active records [cs]

Item (1D) If your organization has implemented an ACAP System and has “ASplit” some or all of the parties' active financial records, please provide the total average number of the parties' active financial records that have been ASplit on your organization's computer systems and networks.
Average Total Number ASplit: [cs]

Item (2A) The average number of in-active customers, clients, patients, staff members and employees and any other parties whose financial records, in electronic format, are available on your organization's computer system(s)—the total average number of in-active customers, clients, patients, staff members and employees and any other parties whose financial information is available on your organization's computer systems and networks including all back-up systems and achieve systems.
Average Total Number (In-Active): [cs]

Item (2B) If your organization has implemented an ACAP System and has “AWrapped” some or all of the parties' in-active financial records, please provide the total average number of the parties' in-active financial records that have been AWrapped on your organization's computer systems and networks.
Average Total Number AWrapped: [cs]

Item (2C) If your organization has implemented an ACAP System and has “AWrapped” some or all of the parties' in-active financial records, please provide the maximum average number of the parties' in-active financial records that would be unlocked (that is, be opened or non-AWrapped) during a normal days processing operations.
Maximum average number of “unlocked” in-active records [cs]

Item (2D) If your organization has implemented an ACAP System and has “ASplit” some or all of the parties' in-active financial records, please provide the total average number of the parties' in-active financial records that have been ASplit on your organization's computer systems and networks.
Average Total Number ASplit: [cs]

Item (3) The estimated minimum costs and the maximum costs, in dollars, your organization would encounter to settle an average financial records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [cs]
Estimated Maximum Cost: [$25,000] [cs]

Item (4) The estimated percentage of the total number of customers, clients, patients, staff members and employees and any other parties that will make damage claims against your organization if their financial records were compromised.
Estimated Percentage Number: [70%] [cs]
   [4.9] Medical Records

The damage analysis process requires your organization to provide the following information:

Item (1A) The average number of active patients whose medical records, in electronic format, are available on your organization's computer system(s)—the total average number of active patients medical information available on your organization's computer systems and networks.
Average Total Number (Active): [cs]

Item (1B) If your organization has implemented an ACAP System and has “AWrapped” some or all of the patients' active medical records, please provide the total average number of the patients' active medical records that have been AWrapped on your organization's computer systems and networks.
Average Total Number AWrapped: [cs]

Item (1C) If your organization has implemented an ACAP System and has “AWrapped” some or all of the patients' active medical records, please provide the maximum average number of the patients' active medical records that would be unlocked (that is, be opened or non-AWrapped) during a normal days processing operations.
Maximum average number of “unlocked” active records [cs]

Item (1D) If your organization has implemented an ACAP System and has “ASplit” some or all of the patients' active medical records, please provide the total average number of the patients' active medical records that have been ASplit on your organization's computer systems and networks.
Average Total Number ASplit: [cs]

Item (2A) The average number of in-active patients whose medical records, and archived records, in electronic format, are available on your organization's computer system(s)—the total average number of in-active patients medical information available on your organization's computer systems and networks including all back-up systems and achieve systems.
Average Number (In-Active): [cs]

Item (2B) If your organization has implemented an ACAP System and has “AWrapped” some or all of the patients' in-active medical records, please provide the total average number of the patients' active medical records that have been AWrapped on your organization's computer systems and networks.
Average Total Number AWrapped: [cs]

Item (2C) If your organization has implemented an ACAP System and has “AWrapped” some or all of the patients' in-active medical records, please provide the maximum average number of the patients' in-in-active medical records that would be unlocked (that is, be opened or non-AWrapped) during a normal days processing operations.
Maximum average number of “unlocked” in-active records [cs]

Item (2D) If your organization has implemented an ACAP System and has “ASplit” some or all of the patients' in-active medical records, please provide the total average number of the patients' in-active medical records that have been ASplit on your organization's computer systems and networks.
Average Total Number ASplit: [cs]

Item (3) The estimated minimum costs and the maximum costs, in dollars, your organization would encounter to settle an average medical records cyber-negligence damage claim. These values are not to include any legal costs, accounting cost, consultant or advisor costs incurred by your organization. These latter costs are addressed in another segment of the damage assessment process.
Estimated Minimum Cost: [$10,000] [cs]
Estimated Maximum Cost: [$25,000] [cs]

Item (4) The estimated percentage of the total number of patients that will make damage claims against your organization if their medical records were compromised.
Estimated Percentage Number: [70%] [cs]
   [4.10] Password and Access Code Information

The damage analysis process requires your organization to provide the following information:

Item (1) The estimated minimum costs and the maximum costs your organization would encounter to implement the re-keying of your organization's password and access codes system.
Estimated Minimum Cost: [cs]
Estimated Maximum Cost: [cs]
   [4.11] Economic Impact

The damage analysis process requires your organization to provide the following information:

Item (1) The estimated minimum lost income and the maximum lost income, in dollars, that your organization would incur during the period from the initial detection to complete settlement of all disputes related to a cyber-crime attack.
Estimated Minimum Lost Income: [cs]
Estimated Maximum Lost Income: [cs]
   [4.12] Re-Marketing and Public Relations

The damage analysis process requires your organization to provide the following information:

Item (1) The estimated minimum costs and the maximum costs, in dollars, your organization would incur in expenses, fees and costs associated with for the preparation and delivery of a public relation and re-marketing campaign during the period from the initial detection to complete settlement of all disputes related to a cyber-crime attack.
Estimated Minimum Cost: [cs]
Estimated Maximum Cost: [cs]
   [4.13] Legal and Accounting

The damage analysis process requires your organization to provide the following information:

Item (1) The estimated minimum costs and the maximum costs, in dollars, your organization would incur in out-side legal and accounting fees and costs during the period from initial detection to complete settlement of all disputes related to a cyber-crime attack.
Estimated Minimum Cost: [cs]
Estimated Maximum Cost: [cs]
   [4.14] Ancillary Costs

The damage analysis process requires your organization to provide the following information:

Item (1) The estimated minimum costs and the maximum costs, in dollars, your organization would encounter in ancillary costs during the period from initial detection to complete settlement of all disputes related to a cyber-crime attack.
Estimated Minimum Cost: [cs]
Estimated Maximum Cost: [cs]

Forward-Looking Notice:

These review and analysis results and information are based on certain assumptions and analysis made by ACAP Security Inc., and its agents and affiliates, in light of their experience and perception of historical trends, current conditions and expected future developments, as well as other factors believed to be appropriate in the circumstances. However, whether actual results, developments, events and activities will conform to these expectations and predictions is subject to a number of risks and uncertainties that could cause actual results to differ materially from expectations.

All statements, other than statements of historical facts, included or referenced in this review and analysis, which address activities, events or developments, that are expected or anticipated, will or may occur in the future are forward-looking statements. The words “believe,” “intend,” “expect,” “anticipate,” “project,” “estimate,” “predict” and similar expressions also identify forward-looking statements.

Consequently, all of the forward-looking results and information made by this review and analysis are qualified by these cautionary statements, and there can be no assurance that the actual results, developments, events or activities anticipated will be realized or, even if substantially realized, that they will have the expected consequences to, or effects on, the reviewed and analyzed organization's business or operations. ACAP Security Inc., and of its all agents and affiliates, assumes no obligation to update any such forward-looking results and information, whether as a result of new information, future events or otherwise.

{End of Standard Damage Assessment Report}

In a similar manner the embodiment sample standard damage assessment report (1006) of a damage sensitivity assessment CDAEM function in accordance with methods and systems consistent with the present invention may typically include such information as:

Damage Sensitivity Analysis Report
Report Preparation Time: [cs]
Report Preparation Date: [cs]
Please provide a Damage Sensitivity Summary Report Identification Number: [us]
Report Data Submittal Time: [cs]
Report Data Submittal Date: [cs]
Report Data Standard Damage Assessment Identification Number: [cs]
Data on party providing submitted data:
Name: [cs]
ID Number: [cs]
Phone number: [cs]
e-mail address: [cs]
Organization ID number: [cs]
Organization Name: [cs]
Street Address: [cs]
City: [cs]
State: [cs]
Zip: [cs]
Phone number: [cs]
Fax number: [cs]
e-mail address: [cs]
Topic selected for sensitivity study: [cs—provide topic name-title]
Parameter selected for sensitivity study: [cs—provide parameter name]
Baseline value parameter is: [cs]
Sensitivity study increment selected:
Four higher values: [cs-one]
   [cs-two]
   [cs-three]
   [cs-four]
Four lower values: [cs-one]
   [cs-two]
   [cs-three]
   [cs-four]

Estimated Assessment of Various Loss Exposures from a Cyber-crime Attack

| | Lower Value Results | | | | |
|---|---|---|---|---|---|
| | [cs] | [cs] | [cs] | [cs] | [cs] |
| Total Loss Exposure | $ [LE] | . . . | . . . | . . . | $ [LE] |
| Damage Claim Loss Exposure | $ [DL] | . . . | . . . | . . . | $ [DL] |
| Cash Losses and Expenses | $ [CE] | . . . | . . . | . . . | $ [CE] |
| Exposure | | | | | |
| Criminal Cash Value | $ [CV] | . . . | . . . | . . . | $ [CV] |
| | Higher Value Results | | | | |
| | [cs] | [cs] | [cs] | [cs] | [cs] |
| Total Loss Exposure | $ [LE] | . . . | . . . | . . . | $ [LE] |
| Damage Claim Loss Exposure | $ [DL] | . . . | . . . | . . . | $ [DL] |
| Cash Losses and Expenses | $ [CE] | . . . | . . . | . . . | $ [CE] |
| Exposure | | | | | |
| Criminal Cash Value | $ [CV] | . . . | . . . | . . . | $ [CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Estimated Assessment of Damage Ranges with [cs]

| | |
|---|---|
| Total Loss Exposure | $ [LE] |
| Damage Claim Loss Exposure | $ [DL] |
| Cash Losses and Expenses Exposure | $ [CE] |
| Criminal Cash Value | $ [CV] |

| | Estimated Damages | |
|---|---|---|
| | Minimum ($) | Maximum ($) |
| Potential Damages Claims | [Min-DL] | [Max-DL] |
| Potential Cash Losses & Expenses | [Min-CE] | [Max-CE] |
| Total Estimated Damage | $ [TMinD] | $ [TMaxD] |
| Criminal Cash Value | [Min-CV] | [Max-CV] |

Forward-Looking Notice:

These review and analysis results and information are based on certain assumptions and analysis made by ACAP Security Inc., and its agents and affiliates, in light of their experience and perception of historical trends, current conditions and expected future developments, as well as other factors believed to be appropriate in the circumstances. However, whether actual results, developments, events and activities will conform to these expectations and predictions is subject to a number of risks and uncertainties that could cause actual results to differ materially from expectations.

All statements, other than statements of historical facts, included or referenced in this review and analysis, which address activities, events or developments, that are expected or anticipated, will or may occur in the future are forward-looking statements. The words “believe,” “intend,” “expect,” “anticipate,” “project,” “estimate,” “predict” and similar expressions also identify forward-looking statements.

Consequently, all of the forward-looking results and information made by this review and analysis are qualified by these cautionary statements, and there can be no assurance that the actual results, developments, events or activities anticipated will be realized or, even if substantially realized, that they will have the expected consequences to, or effects on, the reviewed and analyzed organization's business or operations. ACAP Security Inc., and of its all agents and affiliates, assumes no obligation to update any such forward-looking results and information, whether as a result of new information, future events or otherwise.

{End of Damage Sensitivity Analysis Report}

1. A Cyber-Security Damage Assessment and Evaluation Measurement (CDAEM) system comprising:
a set of one through “n” functions or sub-functions each which addresses a operational topic, capability or activity which is either required or desired to be performed in the accomplishment of the mission, task or objective of an organization, entity or individual, where the functions and/or sub-functions by analytical representations either simulates or emulates one or more operational topics, capabilities or activities in the context of a cyber-crime attack, cyber-terror attack or other man-made or natural disaster;
one or more input modules or functions that accept user defined actual or desired operational parameters for each function and/or sub-function;
one or more input modules or functions that accept user defined sensitivity study parameters for various functions and/or sub-functions;
one or more analytical models which translate operational topics, capabilities or activities into dollar definitive representations and transcend the incompatibility of mapping an operational environment into a financial model which is related to disaster losses and dollar loss potentials and/or exposures;
one or more output modules or functions which provide definitive dollar representations of direct losses, economic losses and damage claim losses based upon the user defined actual or desired operational parameters for each functions and/or sub-functions.

2. Wherein the user of the CDAEM system defined in claim 1 has the capabilities to use the system in a stand alone, single computer or digital device configuration, or as part of a configuration that includes a network of computers and digital devices.

3. Wherein the user of the CDAEM defined in claim 1 has the capabilities to use the device in a direct user present at the computer or digital device configuration, or as part of remote access configuration which may include wireline, wireless or other modes of communications.

4. Wherein the user of the CDAEM system defined in claim 1 has the capabilities to use the system in a stand alone, single operations mode, or as part of a configuration that includes a network or grouping of CDAEM type of systems or other systems methods or apparatuses which use modules or function to represent or to addresses a operational topic, capability or activity which is either required or desired to be performed in the accomplishment of the mission, task or objective of an organization, entity or individual.
